(19) United States
(12) Patent Application Publication
(10) Pub. No.: US 2020/0380702 A1
(43) Pub. Date: Dec. 3, 2020

(54) FACE TRACKING METHOD AND APPARATUS, AND STORAGE MEDIUM

(71) Applicant: TENCENT TECHNOLOGY (SHENZHEN) COMPANY LIMITED, Shenzhen (CN)

(72) Inventors: Chang Wei He, Shenzhen (CN); Cheng Jie Wang, Shenzhen (CN); Ji Lin Li, Shenzhen (CN); Jin Long Peng, Shenzhen (CN); Ya Biao Wang, Shenzhen (CN); Yan Dan Zhao, Shenzhen (CN); Zhen Ye Gan, Shenzhen (CN); Yong Jian Wu, Shenzhen (CN); Fei Yue Huang, Shenzhen (CN)

(73) Assignee: TENCENT TECHNOLOGY (SHENZHEN) COMPANY LIMITED, Shenzhen (CN)

(21) Appl. No.: 16/995,109

(22) Filed: Aug. 17, 2020

Related U.S. Application Data
(63) Continuation of application No. PCT/CN2019/092311, filed on Jun. 21, 2019.

(30) Foreign Application Priority Data
Jul. 16, 2018 (CN) 201810776248.5

(51) Int. Cl. G06T 7/246; G06T 7/70; G06K 9/00

(52) U.S. Cl. CPC G06T 7/248; G06T 7/70; G06T 2207/10016; G06T 2207/30201; G06T 2207/30241; G06K 9/00228

(57) ABSTRACT

A method of tracking a face includes determining a current frame from video stream data in response to receiving a face tracking instruction; detecting a position of a face in the current frame, and obtaining a historical motion trajectory of the face in the current frame; predicting the position of the face in the current frame based on the historical motion trajectory to obtain a predicted position of the face; obtaining a correlation matrix of the historical motion trajectory and the face in the current frame based on the predicted position and the detected position; and updating the historical motion trajectory based on the correlation matrix, and tracking the face in a next frame based on the updated historical motion trajectory.

### CROSS-REFERENCE TO RELATED APPLICATION(S)

This application is a bypass continuation application of International Application No. PCT/CN2019/092311, filed Jun. 21, 2019, which claims priority to Chinese Patent Application No. 201810776248.5, filed with the China National Intellectual Property Administration on Jul. 16, 2018 and entitled “FACE TRACKING METHOD AND APPARATUS, AND STORAGE MEDIUM”, the disclosures of which are herein incorporated by reference in their entireties.

### FIELD

The disclosure relates to the field of communication technologies, and specifically, to a face tracking method and a face tracking apparatus, and a computer readable storage medium therefor.

### BACKGROUND

Face tracking is a technology of tracking a trajectory of a face in video images and obtaining a face coordinate box (or face bounding box) position and identification (ID) of each person in each image frame. Face tracking is widely used in the field of intelligent surveillance and control. Through accurate face tracking, behaviors of pedestrians may be analyzed, such as fights, affray or theft. Therefore, security personnel may respond in time based on face tracking.

### SUMMARY

According to an aspect of an example embodiment of the disclosure, provided is a method of tracking a face, the method including:

determining a current frame from video stream data in response to receiving a face tracking instruction;

detecting a position of a face in the current frame, and obtaining a historical motion trajectory of the face in the current frame;

predicting the position of the face in the current frame based on the historical motion trajectory to obtain a predicted position of the face;

obtaining a correlation matrix of the historical motion trajectory and the face in the current frame based on the predicted position and the detected position; and

updating the historical motion trajectory based on the correlation matrix, and tracking the face in a next frame based on the updated historical motion trajectory.

According to an aspect of an example embodiment of the disclosure, provided is an apparatus for tracking a face, the apparatus including:

at least one memory configured to store program code; and

at least one processor configured to read the program code and operate as instructed by the program code, the program code including:
determining code configured to cause at least one of the at least one processor to determine a current frame from video stream data in response to receiving a face tracking instruction;
detecting code configured to cause at least one of the at least one processor to detect a position of a face in the current frame;
first obtaining code configured to cause at least one of the at least one processor to obtain a historical motion trajectory of the face in the current frame;
predicting code configured to cause at least one of the at least one processor to predict the position of the face in the current frame based on the historical motion trajectory to obtain a predicted position of the face;
second obtaining code configured to cause at least one of the at least one processor to obtain a correlation matrix of the historical motion trajectory and the face in the current frame based on the predicted position and the detected position; and
updating code configured to cause at least one of the at least one processor to update the historical motion trajectory based on the correlation matrix, and track the face in a next frame based on the updated historical motion trajectory.

According to an aspect of an example embodiment of the disclosure, provided is a network device, including at least one processor; and at least one memory, configured to store instructions executable by the at least one processor to perform the face tracking method provided by one or more embodiments of the disclosure.

According to an aspect of an example embodiment of the disclosure, provided is a non-transitory computer readable storage medium, storing a plurality of instructions, the plurality of instructions being executable by at least one processor to cause the at least one processor to perform:

determining a current frame from video stream data in response to receiving a face tracking instruction;

detecting a position of a face in the current frame, and obtaining a historical motion trajectory of the face in the current frame;

predicting the position of the face in the current frame based on the historical motion trajectory to obtain a predicted position of the face;

obtaining a correlation matrix of the historical motion trajectory and the face in the current frame based on the predicted position and the detected position; and

updating the historical motion trajectory based on the correlation matrix, and tracking the face in a next frame based on the updated historical motion trajectory.

### BRIEF DESCRIPTION OF THE DRAWINGS

To describe the technical solutions of the embodiments of the disclosure more clearly, the following briefly introduces the accompanying drawings for describing the embodiments or the related art. Apparently, the accompanying drawings in the following description show only some embodiments of the disclosure, and a person of ordinary skill in the art may still derive other embodiments and/or drawings according to the accompanying drawings without creative efforts.

FIG. 1A is a schematic diagram of a scenario of a face tracking method according to an embodiment of the disclosure.

FIG. 1B is a flowchart of a face tracking method according to an embodiment of the disclosure.

FIG. 2A is another flowchart of a face tracking method according to an embodiment of the disclosure.

FIG. 2B is an example diagram of a motion trajectory in a face tracking method according to an embodiment of the disclosure.

FIG. 3 is a schematic structural diagram of a face tracking apparatus according to an embodiment of the disclosure.

FIG. 4 is a schematic structural diagram of a network device according to an embodiment of the disclosure.

### DETAILED DESCRIPTION

The following clearly and completely describes the technical solutions in the embodiments of the disclosure with reference to the accompanying drawings in the embodiments of the disclosure. Apparently, the described embodiments are merely some embodiments of the disclosure rather than all of the embodiments. All other embodiments obtained by a person skill in the art based on the embodiments of the disclosure without making creative efforts shall fall within the protection scope of the disclosure.

In face tracking in the related technology, a position box of a face in each image frame is generally detected by using a detection method, and then faces in image frames are associated with each other by using an adjacent frame target association algorithm to obtain a face trajectory of the face. However, in a case that the face is blocked or a face pose changes, an association failure or an association error easily occurs, causing an interruption of the face trajectory and greatly affecting the effect of the face tracking.

Embodiments of the disclosure provide a face tracking method, a face tracking apparatus, and a computer readable storage medium therefor. The face tracking method provided by the disclosure may enhance the continuity of the face trajectory and improve the effect and the accuracy of the face tracking.

The face tracking apparatus may be integrated in a network device. The network device may be a device such as a terminal or a server.

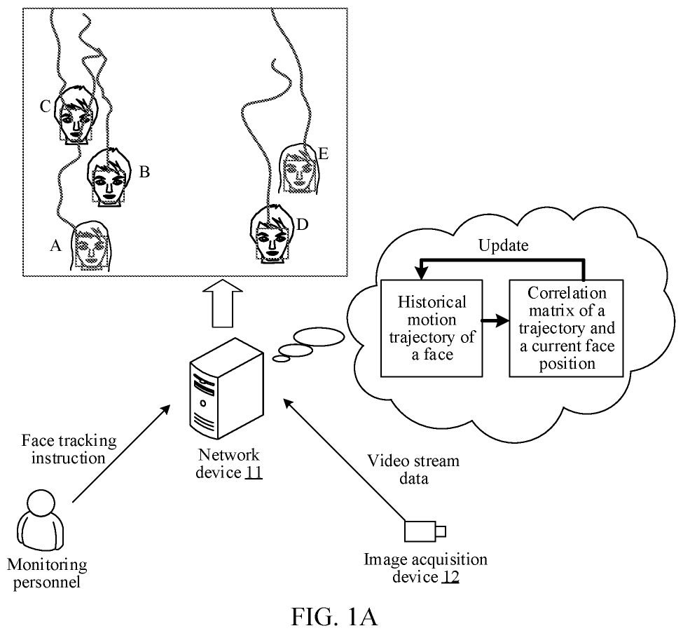

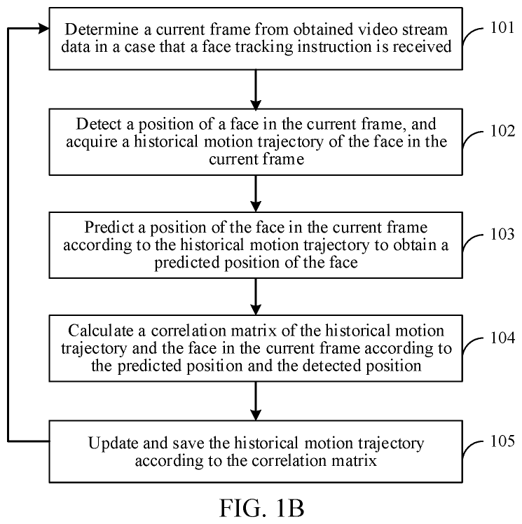

FIG. 1A is a schematic diagram of a scenario of a face tracking method according to an embodiment of the disclosure. As shown in FIG. 1A, the scenario of the face tracking method according to an embodiment of the disclosure includes a network device 11 and an image acquisition device 12, where

the network device 11 may be a device such as a terminal or a server, and the face tracking apparatus may be integrated in the network device 11; and

the image acquisition device 12 may be a camera device configured to obtain video stream data, such as a camera.

In some embodiments, for example, the face tracking apparatus is integrated in the terminal, and the terminal is, for example, a monitoring device in a monitoring room. In a case that the monitoring device receives a face tracking instruction triggered by a monitoring personnel, a current frame may be determined from acquired video stream data, a position of a face in the current frame is detected, and a historical motion trajectory of the face in the current frame is obtained. Then, a position of the face in the current frame is predicted according to the historical motion trajectory, and a correlation matrix of the historical motion trajectory and the face in the current frame is calculated according to the predicted position and the previously detected position, thereby obtaining a correlation between the historical motion trajectory and the face in the current frame. Therefore, even if the position of the face in the current frame is not accurately detected or cannot be detected, a “face motion trajectory” may still be extended to the current frame.

Then, the monitoring device may update the historical motion trajectory according to the correlation (that is, the correlation matrix). The updated historical motion trajectory is a motion trajectory of the face in the current frame and is a historical motion trajectory of the next frame (or next several frames) of the current frame. The updated historical motion trajectory may be saved. Therefore, the updated historical motion trajectory may be directly obtained as a historical motion trajectory of the next “current frame” subsequently. After the historical motion trajectory is updated and saved, an operation of determining a current frame to be next analyzed from obtained video stream data may be performed (that is, tracking the face in the next frame is performed based on the updated historical motion trajectory). The foregoing operations are repeatedly performed so that the face motion trajectory may be continuously extended and updated until the face tracking is completed.

In an embodiment of the disclosure, the face tracking method is described from the perspective of the face tracking apparatus. The face tracking apparatus may be specifically integrated in a network device, that is, the face tracking method may be performed by the network device. The network device may be a device such as a terminal or a server, where the terminal may include a monitoring device, a tablet computer, a notebook computer, a personal computer (PC) or the like.

In some embodiments, an embodiment of the disclosure provides a face tracking method, including: determining a current frame from obtained video stream data in a case that a face tracking instruction is received; detecting a position of a face in the current frame, and obtaining a historical motion trajectory of the face in the current frame; then, predicting a position of the face in the current frame according to the historical motion trajectory, and calculating a correlation matrix of the historical motion trajectory and the face in the current frame according to the predicted position and the detected position; and then, updating and saving the historical motion trajectory according to the correlation matrix, and returning to perform the operation of determining a current frame to be next analyzed from obtained video stream data, until the face tracking is completed. Here, the expression “returning to perform the operation of determining a current frame to be next analyzed from obtained video stream data, until the face tracking is completed” or similar expressions are intended to mean that tracking of the face in the next frame is performed based on the updated historical motion trajectory, and tracking of the face is repeated for remaining frames until the face tracking for all of the frames is completed.

FIG. 1B is a flowchart of a face tracking method according to an embodiment of the disclosure. As shown in FIG. 1B, the face tracking method may include operations 101-105:

101. Determine a current frame from obtained video stream data in a case that a face tracking instruction is received.

The face tracking instruction may be triggered by a user or another device (for example, another terminal or server). The video stream data may be acquired by the face tracking apparatus, or may be acquired by another device, such as a camera device or a monitoring device, and then provided to the face tracking apparatus. That is, for example, operation 101 may be as follows:

acquiring video stream data in a case that the face tracking instruction triggered by the user is received, and determining the current frame from the acquired video stream data; or

receiving, in a case that the face tracking instruction triggered by the user is received, video stream data transmitted by the camera device or the monitoring device, and determining the current frame from the received video stream data; or

acquiring video stream data in a case that the face tracking instruction transmitted by another device is received, and determining the current frame from the acquired video stream data; or

receiving, in a case that the face tracking instruction transmitted by another devices is received, video stream data transmitted by the camera device or the monitoring device, and determining the current frame from the received video stream data.

102. Detect a position of a face in the current frame, and obtain a historical motion trajectory of the face in the current frame.

The historical motion trajectory of the face in the current frame refers to a motion trajectory of a face in a video stream data segment within a previous preset time range, relative to the current frame as a reference point.

In this operation, an execution sequence of detecting the face position and obtaining the historical motion trajectory is not particularly limited. The operation of detecting the face position may not be performed in operation 102, provided that the face position is detected before the operation of determining “a correlation between the historical motion trajectory and the face in the current frame” (that is, operation 104). During detection of the face position, a suitable algorithm may be flexibly selected according to requirements. For example, the position of the face in the current frame may be detected by using a face detection algorithm.

The face detection algorithm may be determined according to actual application requirements, and details are not described herein again. The position of the face may be an actual position of the face in a frame. In addition, for the convenience of subsequent calculations, the position of the face may generally be a position of a coordinate box (or a bounding box) of the face, that is, the operation of “detecting the position of the face in the current frame by using a face detection algorithm” may be:

detecting the position of the coordinate box of the face in the current frame by using the face detection algorithm.

For the convenience of description, in an embodiment of the disclosure, the position of the face in the current frame obtained through detection is referred to as a detected position of the face in the current frame (which is different from a predicted position, where the predicted position will be described in detail in the following).

In some embodiments, the historical motion trajectory of the face in the current frame may be obtained in various manners. For example, if the historical motion trajectory of the face in the current frame already exists, for example, if the historical motion trajectory has already been stored in preset storage space, the historical motion trajectory may be directly read from the preset storage space. However, if the historical motion trajectory does not exist currently, the historical motion trajectory may be generated, that is, the operation of “obtaining a historical motion trajectory of the face in the current frame” may include:

determining whether the historical motion trajectory of the face in the current frame exists; reading the historical motion trajectory of the face in the current frame in a case that the historical motion trajectory exists; and generating the historical motion trajectory of the face in the current frame in a case that the historical motion trajectory does not exist, for example:

obtaining, from the obtained video stream data, a video stream data segment within a previous preset time range, relative to the current frame as a reference point, detecting positions of faces in all frames of images in the video stream data segment, generating motion trajectories of all the faces according to the positions, and selecting the historical motion trajectory of the face in the current frame from the generated motion trajectories.

The preset time range may be determined according to actual application requirements, for example, the preset time range may be set to “30 seconds” or “15 frames”, or the like. Additionally, if a plurality of faces exist in an image, a plurality of motion trajectories may be generated so that each face corresponds to a historical trajectory.

In general, at the beginning of face tracking in certain video stream data (the current frame is the first frame), no historical motion trajectory exists. Therefore, “generating the historical motion trajectory of the face in the current frame” may be considered as “initializing the trajectory” in this case.

103. Predict a position of the face in the current frame according to the historical motion trajectory to obtain a predicted position (that is, the predicted position of the face in the current frame); for example, the operation may be as follows:

(1) Calculate a movement speed of the face in the historical motion trajectory by using a preset algorithm to obtain a trajectory speed.

The trajectory speed may be calculated in various manners. For example, key point information of the face in the historical motion trajectory may be calculated by using a face registration algorithm, then the key point information is fitted by using a least-squares method to obtain a movement speed vector of the face in the historical motion trajectory, and the movement speed vector is taken as the trajectory speed.

The key point information may include information of feature points, such as, for example but not limited to, a face contour, eyes, eyebrows, lips, and a nose contour.

In some embodiments, to improve the accuracy of calculation, the movement speed vector may be adjusted according to a triaxial angle of a face in the last frame of an image in the historical motion trajectory, that is, the operation of “calculating a movement speed of the face in the historical motion trajectory by using a preset algorithm to obtain a trajectory speed” may alternatively include:

calculating key point information of the face in the historical motion trajectory by using a face registration algorithm; fitting the key point information by using a least-squares method to obtain a movement speed vector of the face in the historical motion trajectory; calculating a triaxial angle of the face in the last frame of an image in the historical motion trajectory by using a face pose estimation algorithm; and adjusting the movement speed vector according to the triaxial angle to obtain the trajectory speed.

An adjustment method may be set according to actual application requirements. For example, a direction vector of the face in the last frame of an image may be calculated according to the triaxial angle, and then a weighted average of the movement speed vector and the direction vector is calculated to obtain the trajectory speed, which is expressed by the following formula:

v(a)=w·b+(1−w)·d·∥b∥₂

where v(a) is a trajectory speed, d is a direction vector of the face in the last frame of an image, b is a movement speed vector of the face in the historical motion trajectory, and w is a weight; the weight may be set according to actual application requirements, for example, the value range may be [0, 1].

(2) Predict the position of the face in the current frame according to the trajectory speed and the historical motion trajectory to obtain a predicted position, which, for example, may be as follows:

obtaining a position of the face in the last frame of an image in the historical motion trajectory, and then predicting the position of the face in the current frame according to the trajectory speed and the position of the face in the last frame of an image to obtain the predicted position.

For example, a frame difference between the current frame and the last frame may be calculated, and a product of the frame difference and the trajectory speed is calculated, and then a sum of the product and the position of the face in the last frame is calculated to obtain the predicted position, which is expressed by the following formula:

p′=p+v(a)·Δ

where p′ is a predicted position of the face in the current frame, p is a position of the face in the last frame of an image, v(a) is a trajectory speed, and Δ is a frame difference between the current frame and the last frame.

104. Calculate a correlation matrix of the historical motion trajectory and the face in the current frame according to the predicted position and the detected position; for example, the operation may be as follows:

(1) Calculate a degree of coincidence between the predicted position and the detected position.

For example, an area of intersection and an area of union between a coordinate box (or a bounding box) in which the predicted position is located and a coordinate box (or a bounding box) in which the detected position is located is determined, and the degree of coincidence between the predicted position and the detected position is calculated according to the area of intersection and the area of union.

For example, the area of intersection may be divided by the area of union, to obtain the degree of coincidence between the predicted position and the detected position.

(2) Calculate the correlation matrix of the historical motion trajectory and the face in the current frame according to the degree of coincidence.

For example, a bipartite graph may be drawn according to the calculated degree of coincidence, and then the correlation matrix is calculated by using an optimal bipartite matching method, or the like.

The correlation matrix may reflect a correlation between the historical motion trajectory and the face in the current frame.

105. Update and save the historical motion trajectory according to the correlation matrix, and return to perform the operation of determining a current frame to be next analyzed from obtained video stream data (that is, return to operation 101 to “determine a current frame from obtained video stream data”), till the face tracking is completed.

For example, if the current frame is the third frame, after the historical motion trajectory is updated and saved according to the correlation matrix, the fourth frame becomes the current frame, and then, operations 102 to 105 are continued to be performed. Then, the fifth frame becomes the current frame, and operations 102 to 105 are continued to be performed. The remaining process may be performed in the same manner, e.g., until an end instruction for the face tracking is received.

It may be learned from the above that in an embodiment, a current frame is determined from obtained video stream data in a case that a face tracking instruction is received; a position of a face in the current frame is detected, and a historical motion trajectory of the face in the current frame is obtained; then, a position of the face in the current frame is predicted according to the historical motion trajectory; a correlation matrix of the historical motion trajectory and the face in the current frame is calculated according to the predicted position and the detected position; and then the historical motion trajectory is updated and saved according to the correlation matrix, and the operation of determining a current frame to be analyzed from obtained video stream data is performed again, until the face tracking is completed. In this solution, the motion trajectory may be updated according to the correlation matrix of the historical motion trajectory and the face in the current frame. Therefore, even if faces in some frames are blocked or a face pose changes, the motion trajectory will not be interrupted. That is, the solution may enhance the continuity of a face trajectory, thereby improving the effect and accuracy of the face tracking.

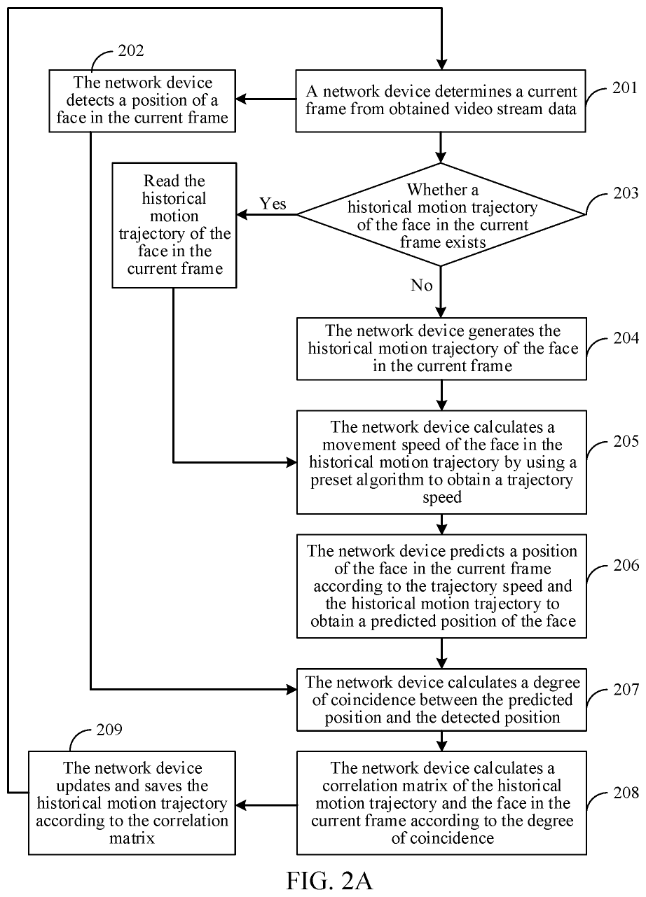

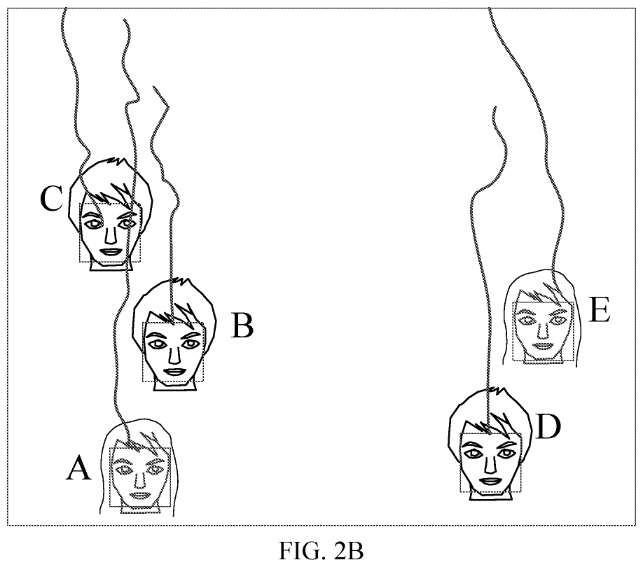

FIG. 2A is another flowchart of a face tracking method according to an embodiment of the disclosure. As shown in FIG. 2A, an embodiment of the disclosure provides a face tracking method, performed by a network device. A face tracking apparatus is integrated in the network device. The process may include operations 201-209:

201. The network device determines a current frame from obtained video stream data in a case that a face tracking instruction is received.

The face tracking instruction may be triggered by a user or another device, for example, another terminal or server. The video stream data may be acquired by the face tracking apparatus, or may be acquired by another device, such as a camera device or a monitoring device, and then provided to the face tracking apparatus.

202. The network device detects a position of a face in the current frame.

In some embodiments, the network device may detect the position of the face in the current frame by using a face detection algorithm. The position of the face may be a position of a coordinate box of the face. FIG. 2B is an example diagram of a motion trajectory in a face tracking method according to an embodiment of the disclosure. Blocks (or boxes) in FIG. 2B are positions of coordinate boxes of faces in the current frame. The positions of the coordinate boxes of the faces in the current frame may be detected by using the face detection algorithm.

The face detection algorithm may be determined according to actual application requirements, and details are not described herein again.

An operation of detecting the face position by the network device only needs to be performed before the operation of “calculating a degree of coincidence between the predicted position and the detected position” (that is, operation 207). That is, operation 202 and operations 203 to 206 may be performed in any sequence. Operation 202 may be performed at any time after operation 201 and before operation 207, and may be performed in sequence with any one of operations 203 to 206, or may be performed in parallel with any one of operations 203 to 206, which may be determined according to actual application requirements, and details are not described herein again.

203. The network device determines whether a historical motion trajectory of the face in the current frame exists, reads the historical motion trajectory of the face in the current frame in a case that the historical motion trajectory exists, and then performs operation 205; the network device performs operation 204 in a case that the historical motion trajectory does not exist.

For example, as shown in FIG. 2B, a face A, a face B, a face C, a face D, and a face E exist in the current frame. In this case, whether historical motion trajectories of the face A, the face B, the face C, the face D, and the face E exist in preset storage space (which may be local storage space or cloud storage space) may be determined. For a face having an existing historical motion trajectory, the historical motion trajectory may be read from the storage space; for a face without an existing historical motion trajectory, operation 204 is performed to generate a corresponding historical motion trajectory.

For example, if corresponding historical motion trajectories of the face A, the face B, the face D, and the face E exist in the preset storage space, while a corresponding historical motion trajectory of the face C does not exist in the preset storage space, the historical motion trajectories of the face A, the face B, the face D, and the face E may be read from the storage space, while the historical motion trajectory of the face C needs to be generated by performing operation 204.

204. The network device generates the historical motion trajectory of the face in the current frame, and then performs operation 205.

In some embodiments, the network device may obtain, from the obtained video stream data, a video stream data segment within a previous preset time range, relative to the current frame as a reference point, then detect positions of faces in all frames of images in the video stream data segment, and generate motion trajectories of all the faces according to the positions. For example, referring to FIG. 2B, a plurality of motion trajectories of faces, including the face A, the face B, the face C, the face D, and the face E, may be generated (curves in FIG. 2B are the motion trajectories of the faces). The historical motion trajectory of the face in the current frame is selected from the generated motion trajectories. For example, the required historical motion trajectory of the face C is selected.

The preset time range may be determined according to actual application requirements, for example, the preset time range may be set to “30 seconds” or “15 frames”, or the like.

In some embodiments, to improve the efficiency of processing, a motion trajectory may not be generated for a face that has a historical motion trajectory, and a historical motion trajectory is generated only for a face that does not have a historical motion trajectory. That is, the network device may also determine a face (such as, the face C), for which a historical motion trajectory needs to be generated, in the current frame, and then detect a position of the face, for which the historical motion trajectory needs to be generated, in each frame of image in obtained video stream data segment, and generate, according to each position, a historical motion trajectory of the face for which the historical motion trajectory needs to be generated. Therefore, it is unnecessary to perform the operation of “selecting the historical motion trajectory of the face in the current frame from the generated motion trajectories”.

205. The network device calculates a movement speed of the face in the historical motion trajectory by using a preset algorithm to obtain a trajectory speed.

The trajectory speed may be calculated in various manners. For example, key point information of the face in the historical motion trajectory may be calculated by using a face registration algorithm, then the key point information is fitted by using a least-squares method to obtain a movement speed vector of the face in the historical motion trajectory, and the movement speed vector is taken as the trajectory speed.

The key point information may include information of feature points, such as, for example but not limited to, a face contour, eyes, eyebrows, lips, and a nose contour.

In some embodiments, to improve the accuracy of a calculation, the movement speed vector may be adjusted according to a triaxial angle of a face in the last frame of an image in the historical motion trajectory, that is, operation 205 may also be as follows:

the network device calculates key point information of the face in the historical motion trajectory by using a face registration algorithm; fits the key point information by using a least-squares method to obtain a movement speed vector of the face in the historical motion trajectory; calculates a triaxial angle (α, β, γ) of the face in the last frame of an image in the historical motion trajectory by using a face pose estimation algorithm; and adjusts the movement speed vector according to the triaxial angle (α, β, γ) to obtain the trajectory speed.

An adjustment method may be set according to actual application requirements. For example, a direction vector of the face in the last frame of an image may be calculated according to the triaxial angle (α, β, γ), and then a weighted average of the movement speed vector and the direction vector is calculated to obtain the trajectory speed, which is expressed by the following formula:

v(a)=w·b+(1−w)·d·∥b∥₂

where v(a) is a trajectory speed, d is a direction vector of the face in the last frame of an image, b is a movement speed vector of the face in the historical motion trajectory, and w is a weight; the weight may be set according to actual application requirements, for example, the value range may be [0, 1].

For example, if a trajectory speed of the face A is to be calculated, key point information of the face A in the historical motion trajectory of the face A is calculated by using a face registration algorithm. Then, the key point information is fitted by using a least-squares method to obtain a movement speed vector b of the face A in the historical motion trajectory, and then a triaxial angle (α, β, γ) of the face A in the last frame of an image is calculated by using a face pose estimation algorithm. The direction vector d of the face A in the last frame of an image is calculated according to the triaxial angle (α, β, γ), then the movement speed vector b and the direction vector d are calculated to obtain a trajectory speed, and then a weighted average is calculated, so that the trajectory speed of the face A may be obtained. Trajectory speeds of other faces in the current frame may be obtained by using this method, and details are not described herein again.

206. The network device predicts the position of the face in the current frame according to the trajectory speed and the historical motion trajectory to obtain a predicted position of the face. In some embodiments, the network device obtains a position of the face in the last frame of an image in the historical motion trajectory, and then predicts the position of the face in the current frame according to the trajectory speed and the position of the face in the last frame of an image to obtain the predicted position.

In some embodiments, a frame difference between the current frame and the last frame may be calculated, and a product of the frame difference and the trajectory speed is calculated. Then, a sum of the product and the position of the face in the last frame is calculated to obtain the predicted position, which is expressed by the following formula:

p′=p+v(a)·Δ

where p′ is a predicted position of the face in the current frame, p is a position of the face in the last frame of an image, v(a) is a trajectory speed, and Δ is a frame difference between the current frame and the last frame.

Still taking the face A as an example, the network device may obtain a position of the face A in the last frame image, then calculate a frame difference between the current frame and the last frame, calculate a product of the frame difference and the trajectory speed (which is obtained through calculation in operation 205) of the face A, and then calculate a sum of the product and the position of the face A in the last frame, so that the predicted position of the face A in the current frame may be obtained.

207. The network device calculates a degree of coincidence between the predicted position obtained in operation 206 and the detected position obtained in operation 202.

In some embodiments, the network device may determine an area of intersection and an area of union between a coordinate box in which the predicted position is located and a coordinate box in which the detected position is located, and calculate the degree of coincidence between the predicted position and the detected position according to the area of intersection and the area of union. For example, the area of intersection may be divided by the area of union, so that the degree of coincidence between the predicted position and the detected position may be obtained.

Still taking the face A as an example, after the predicted position and the detected position (that is, the detected position) of the face A are obtained, an area of intersection and an area of union between a coordinate box in which the predicted position of the face A is located and a coordinate box in which the detected position of the face A is located are determined, and then the area of intersection may be divided by the area of union, so that the degree of coincidence between the predicted position and the detected position may be obtained.

Degrees of coincidence between predicted positions and detected positions of other faces may also be obtained by using the foregoing method.

208. The network device calculates a correlation matrix of the historical motion trajectory and the face in the current frame according to the degree of coincidence.

In some embodiments, the network device may draw a bipartite graph according to the calculated degree of coincidence, and then calculate the correlation matrix by using an optimal bipartite matching algorithm, or the like.

The correlation matrix may reflect a correlation between the historical motion trajectory and the face in the current frame. For example, a calculated correlation matrix of the face A may reflect a correlation between the historical motion trajectory of the face A and the face A in the current frame. A calculated correlation matrix of the face B may reflect a correlation between the historical motion trajectory of the face B and the face B in the current frame. The rest may be deduced by analogy.

209. The network device updates and saves the historical motion trajectory according to the correlation matrix, and returns to perform the operation of determining a current frame to be next analyzed from obtained video stream data (that is, return to operation 201 to “determine a current frame from obtaining video stream data”), until the face tracking is completed.

In some embodiments, if the current frame is the third frame, after the historical motion trajectory is updated and saved according to the correlation matrix, the fourth frame becomes the current frame, and then, operations 202 to 209 are continued to be performed. Then, the fifth frame becomes the current frame, and operations 202 to 209 are continued to be performed. The remaining process may be performed in the same manner, until an end instruction for the face tracking is received.

The historical motion trajectory may be stored in preset storage space (refer to operation 203), and the storage space may be local storage space or cloud storage space. Therefore, for a face of which a historical motion trajectory has been saved, the corresponding historical motion trajectory may be directly read from the storage space subsequently without generating the historical motion trajectory. For details, reference is made to operation 203, and details are not described herein again.

It may be learned from the above that in an embodiment, a current frame is determined from obtained video stream data in a case that a face tracking instruction is received; a position of a face in the current frame is detected, and a historical motion trajectory of the face in the current frame is obtained; then, a position of the face in the current frame is predicted according to the historical motion trajectory; a correlation matrix of the historical motion trajectory and the face in the current frame is calculated according to the predicted position and the detected position; and then the historical motion trajectory is updated and saved according to the correlation matrix, and the operation of determining a current frame to be analyzed from obtained video stream data is performed again, until the face tracking is completed. In this solution, the motion trajectory may be updated according to the correlation matrix of the historical motion trajectory and the face in the current frame. Therefore, even if faces in some frames are blocked or a face pose changes, the motion trajectory will not be interrupted. That is, the solution may enhance the continuity of a face trajectory, thereby improving the effect and accuracy of the face tracking.

Based on the face tracking method according to the embodiments of the disclosure, the embodiments of the disclosure further provide a face tracking apparatus, where the face tracking apparatus may be integrated in a network device, and the network device may be a device such as a terminal or a server.

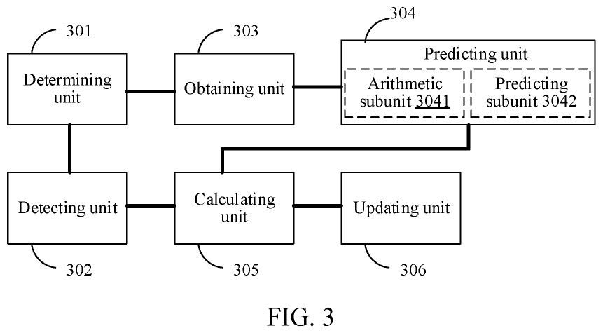

FIG. 3 is a schematic structural diagram of a face tracking apparatus according to an embodiment of the disclosure. As shown in FIG. 3, the face tracking apparatus may include a determining unit 301, a detecting unit 302, an obtaining unit 303, a predicting unit 304, a calculating unit 305, and an updating unit 306. The specific function of each unit is as follows:

(1) Determining unit 301:

the determining unit 301 is configured to determine a current frame from obtained video stream data in a case that a face tracking instruction is received.

The face tracking instruction may be triggered by a user or another device (for example, another terminal or server). The video stream data may be acquired by the face tracking apparatus, or may be acquired by another device, such as a camera device or a monitoring device, and then provided to the face tracking apparatus. Details are not described herein.

(2) Detecting unit 302:

the detecting unit 302 is configured to detect a position of a face in the current frame.

During detection of a face position, a suitable algorithm may be flexibly selected according to requirements. For example, a face detection algorithm may be adopted in the following manner:

the detecting unit 302 may be configured to detect the position of the face in the current frame by using the face detection algorithm, for example, detecting a position of a coordinate box of the face in the current frame.

The face detection algorithm may be determined according to actual application requirements, and details are not described herein again.

(3) Obtaining unit 303:

the obtaining unit 303 is configured to obtain a historical motion trajectory of the face in the current frame.

The obtaining unit 303 may obtain the historical motion trajectory of the face in the current frame in various manners. For example, if the historical motion trajectory of the face in the current frame already exists in a storage, the historical motion trajectory may be directly read from the storage. However, if the historical motion trajectory does not exist, the historical motion trajectory may be generated, that is:

the obtaining unit 303 may be configured to determine whether the historical motion trajectory of the face in the current frame exists, read the existing historical motion trajectory of the face in the current frame in a case that the historical motion trajectory exists, and generate the historical motion trajectory of the face in the current frame in a case that the historical motion trajectory does not exist.

For example, the obtaining unit 303 is configured to obtain, from the obtained video stream data, a video stream data segment within a previous preset time range, relative to the current frame as a reference point, and then detect positions of faces in all frames of images in the video stream data segment, generate motion trajectories of all the faces according to the positions, and then select the historical motion trajectory of the face in the current frame from the generated motion trajectories.

The preset time range may be determined according to actual application requirements, for example, the preset time range may be set to “30 seconds” or “15 frames”, or the like. Additionally, if a plurality of faces exist in an image, the obtaining unit 303 may generate a plurality of motion trajectories, so that each face corresponds to a historical trajectory.

(4) Predicting unit 304:

the predicting unit 304 is configured to predict the position of the face in the current frame according to the historical motion trajectory to obtain the predicted position of the face.

For example, the predicting unit 304 may include an arithmetic subunit and a predicting subunit:

The arithmetic subunit 3041 may be configured to calculate a movement speed of the face in the historical motion trajectory by using a preset algorithm to obtain a trajectory speed.

The predicting subunit 3042 may be configured to predict the position of the face in the current frame according to the trajectory speed and the historical motion trajectory to obtain the predicted position of the face.

The trajectory speed may be calculated in various manners, for example:

The arithmetic subunit 3041 may be configured to calculate key point information of the face in the historical motion trajectory by using a face registration algorithm, fit the key point information by using a least-squares method to obtain a movement speed vector of the face in the historical motion trajectory, and take the movement speed vector as the trajectory speed.

The key point information may include information of feature points, such as, for example but not limited to, a face contour, eyes, eyebrows, lips, and a nose contour.

In some embodiments, to improve the accuracy of calculation, the movement speed vector may be adjusted according to a triaxial angle of a face in the last frame of an image in the historical motion trajectory, that is:

The arithmetic subunit 3041 may be configured to calculate key point information of the face in the historical motion trajectory by using a face registration algorithm; fit the key point information by using a least-squares method to obtain a movement speed vector of the face in the historical motion trajectory; calculate a triaxial angle of the face in the last frame of an image in the historical motion trajectory by using a face pose estimation algorithm; and adjust the movement speed vector according to the triaxial angle to obtain the trajectory speed.

An adjusting method may be set according to actual application requirements, for example:

The calculating unit 305 is configured to calculate a direction vector of the face in the last frame of an image according to the triaxial angle, and calculate a weighted average of the movement speed vector and the direction vector to obtain the trajectory speed, which is expressed the following formula:

v(a)=w·b+(1−w)·d·∥b∥₂

where v(a) is a trajectory speed, d is a direction vector of the face in the last frame of an image, b is a movement speed vector of the face in the historical motion trajectory, and w is a weight; the weight may be set according to actual application requirements, for example, the value range may be [0, 1].

In some embodiments, the predicted position may be calculated in various manners, for example:

The predicting subunit 3042 may be configured to obtain a position of the face in the last frame of an image in the historical motion trajectory, and predict the position of the face in the current frame according to the trajectory speed and the position of the face in the last frame of an image to obtain the predicted position of the face.

For example, the predicting subunit 3042 may be configured to calculate a frame difference between the current frame and the last frame, and calculate a product of the frame difference and the trajectory speed, and calculate a sum of the product and the position of the face in the last frame to obtain the predicted position, which is expressed by the following formula:

p′=p+v(a)·Δ

where p′ is a predicted position of the face in the current frame, p is a position of the face in the last frame of an image, v(a) is a trajectory speed, and Δ is a frame difference between the current frame and the last frame.

(5) Calculating unit 305:

the calculating unit 305 is configured to calculate a correlation matrix of the historical motion trajectory and the face in the current frame according to the predicted position obtained by the predicting unit 304 and the detected position obtained by the detecting unit 302.

For example, the calculating unit 305 may be configured to calculate a degree of coincidence between the predicted position and the detected position, and calculate the correlation matrix of the historical motion trajectory and the face in the current frame according to the degree of coincidence.

For example, the calculating unit 305 may be configured to determine an area of intersection and an area of union between a coordinate box in which the predicted position is located and a coordinate box in which the detected position is located, and calculate the degree of coincidence between the predicted position and the detected position according to the area of intersection and the area of union.

For example, the area of intersection may be divided by the area of union, so that the degree of coincidence between the predicted position and the detected position may be obtained. Afterward, the calculating unit 305 may draw a bipartite graph according to the calculated degree of coincidence, and then calculate the correlation matrix by using an optimal bipartite matching algorithm to obtain a correlation between the historical motion trajectory and the face in the current frame.

(6) Updating unit 306:

the updating unit 306 is configured to update and save the historical motion trajectory according to the correlation matrix, and trigger the determining unit 301 to perform the operation of determining a current frame to be next analyzed from obtained video stream data, until the face tracking is completed.

During specific implementation, the foregoing units may be implemented as independent entities, or may be randomly combined, or may be implemented as the same one or several entities. For specific implementation of the foregoing units, refer to the foregoing method embodiments. Details are not described herein again.

It may be learned from the above that, when the face tracking apparatus of an embodiment receives a face tracking instruction, the determining unit 301 may determine a current frame from obtained video stream data; then the detecting unit 302 detects a position of a face in the current frame, and the obtaining unit 303 obtains a historical motion trajectory of the face in the current frame; then, the predicting unit 304 predicts a position of the face in the current frame according to the historical motion trajectory, and the calculating unit 305 calculates a correlation matrix of the historical motion trajectory and the face in the current frame according to the predicted position and the detected position. Afterward, the updating unit 306 updates and saves the historical motion trajectory according to the correlation matrix, and triggers the determining unit 301 to perform the operation of determining a current frame to be analyzed from obtained video stream data, so that the face motion trajectory may be continuously updated until the face tracking is completed. In the solution, the motion trajectory may be updated according to the correlation matrix of the historical motion trajectory and the face in the current frame. Therefore, even if faces in some frames are blocked or a face pose changes, the motion trajectory will not be interrupted. That is, the solution may enhance the continuity of a face trajectory, thereby improving the effect and accuracy of the face tracking.

The embodiments of the disclosure further provide a network device, which may be a terminal or a server. The network device may integrate any face tracking apparatus according to the embodiments of the disclosure.

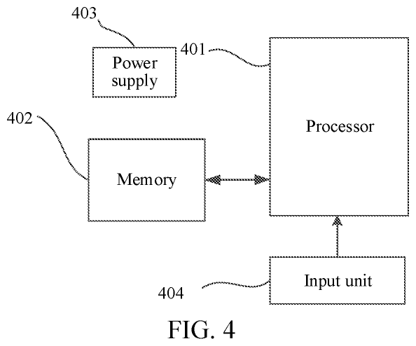

FIG. 4 is a schematic structural diagram of a network device according to an embodiment of the disclosure. As shown in FIG. 4:

the network device may include components such as a processor 401 including one or more processing cores, a memory 402 including one or more computer readable storage media, a power supply 403, and an input unit 404. A person skilled in the art may understand that the structure of the network device shown in FIG. 4 does not constitute a limitation to the network device, and the device may include more components or fewer components than those shown in the figure, or some components may be combined, or a different component deployment may be used.

The processor 401 is a control center of the network device, and is connected to various parts of the entire network device by using various interfaces and lines. By running or executing the software program and/or module stored in the memory 402, and invoking data stored in the memory 402, the processor performs various functions and data processing of the network device, thereby performing overall monitoring on the network device. In some embodiments, the processor 401 may include one or more processing cores, and preferably, the processor 401 may integrate an application processor and a modem processor. The application processor mainly processes an operating system, a user interface, an application program, and the like, and the modem processor mainly processes wireless communication. It is to be understood that the foregoing modem may alternatively not be integrated into the processor 401.

The memory 402 may be configured to store a software program and a module. The processor 401 runs the software program and the module stored in the memory 402, to perform various functional applications and data processing. The memory 402 may mainly include a program storage area and a data storage area. The program storage area may store an operating system, an application program required for at least one function (such as an audio playing function, an image playing function, and the like), and the like. The data storage area may store data created according to use of the network device. Additionally, the memory 402 may include a high speed random access memory, and may further include a non-volatile memory, such as at least one magnetic disk memory device, a flash memory device, or other non-volatile solid state memory devices. Correspondingly, the memory 402 may further include a memory controller, to provide access of the processor 401 to the memory 402.

The network device further includes the power supply 403 that supplies power to each component. Preferably, the power supply 403 may be logically connected to the processor 401 by using a power supply management system, so that functions such as management of charging, discharging, and power consumption are implemented by using the power supply management system. The power supply 403 may further include any component such as one or more direct-current or alternating-current power supplies, a recharging system, a power failure detection circuit, a power converter or inverter, a power status indicator, and the like.

The network device may further include an input unit 404. The input unit 404 may be configured to receive inputted digit or character information, and generate a keyboard, mouse, joystick, optical or track ball signal input related to the user setting and function control.

Although not shown in the figure, the network device may further include a displaying unit, and details are not described herein. In an embodiment, the processor 401 in the network device loads executable files corresponding to processes of one or more application programs into the memory 402 according to the following instructions, and the processor 401 runs the application programs stored in the memory 402 to implement the following various functions:

determining a current frame from obtained video stream data in a case that a face tracking instruction is received; detecting a position of a face in the current frame, and obtaining a historical motion trajectory of the face in the current frame; then, predicting a position of the face in the current frame according to the historical motion trajectory, and calculating a correlation matrix of the historical motion trajectory and the face in the current frame according to the predicted position and the detected position; and then updating and saving the historical motion trajectory according to the correlation matrix, and returning to perform the operation of determining a current frame to be analyzed from obtained video stream data, until the face tracking is completed.

For example, a movement speed of the face in the historical motion trajectory may be calculated by using a preset algorithm to obtain a trajectory speed, and then the position of the face in the current frame is predicted according to the trajectory speed and the historical motion trajectory to obtain the predicted position.

For example, key point information of the face in the historical motion trajectory may be calculated by using a face registration algorithm, and then the key point information is fitted by using a least-squares method to obtain a movement speed vector of the face in the historical motion trajectory, and the movement speed vector is taken as the trajectory speed. Alternatively, a triaxial angle of the face in the last frame of an image in the historical motion trajectory may be calculated by using a face pose estimation algorithm, then the movement speed vector is adjusted according to the triaxial angle, and an adjusted movement speed vector is taken as the trajectory speed.

After the trajectory speed is obtained, a position of the face in the last frame of an image in the historical motion trajectory may be obtained, and the position of the face in the current frame is predicted according to the trajectory speed and the position of the face in the last frame of an image to obtain the predicted position.

For specific implementation of the foregoing operations, reference may be made to the previous embodiments, and details are not described herein again.

It may be learned from the above that, when the network device in an embodiment receives a face tracking instruction, a current frame is determined from obtained video stream data; a position of a face in the current frame is detected, and a historical motion trajectory of the face in the current frame is obtained; then, a position of the face in the current frame is predicted according to the historical motion trajectory; a correlation matrix of the historical motion trajectory and the face in the current frame is calculated according to the predicted position and the detected position; and then the historical motion trajectory is updated and saved according to the correlation matrix, and the operation of determining a current frame to be analyzed from obtained video stream data is performed again, until the face tracking is completed. In this solution, the motion trajectory may be updated according to the correlation matrix of the historical motion trajectory and the face in the current frame. Therefore, even if faces in some frames are blocked or a face pose changes, the motion trajectory will not be interrupted. That is, the solution may enhance the continuity of a face trajectory, thereby improving the effect and accuracy of the face tracking.

A person of ordinary skill in the art may understand that all or some of the operations in the various methods of the embodiments of the disclosure may be completed by using instructions or completed by using related hardware controlled by instructions. The instructions may be stored in a computer readable storage medium, loaded and executed by the processor.

Therefore, an embodiment of the disclosure provides a storage medium storing a plurality of instructions, and the instructions can be loaded by a processor to perform the operations in any face tracking method according to the embodiments of the disclosure. For example, the instructions may perform the following operations:

determining a current frame from obtained video stream data in a case that a face tracking instruction is received; detecting a position of a face in the current frame, and obtaining a historical motion trajectory of the face in the current frame; then, predicting a position of the face in the current frame according to the historical motion trajectory, and calculating a correlation matrix of the historical motion trajectory and the face in the current frame according to the predicted position and the detected position; and then updating and saving the historical motion trajectory according to the correlation matrix, and returning to perform the operation of determining a current frame to be analyzed from obtained video stream data, until the face tracking is completed.

For example, a movement speed of the face in the historical motion trajectory may be calculated by using a preset algorithm to obtain a trajectory speed, and then the position of the face in the current frame is predicted according to the trajectory speed and the historical motion trajectory to obtain the predicted position.

For example, key point information of the face in the historical motion trajectory is calculated by using a face registration algorithm, then the key point information is fitted by using a least-squares method to obtain a movement speed vector of the face in the historical motion trajectory, and the movement speed vector is taken as the trajectory speed. Alternatively, a triaxial angle of the face in the last frame of an image in the historical motion trajectory may be calculated by using a face pose estimation algorithm, then the movement speed vector is adjusted according to the triaxial angle, and an adjusted movement speed vector is taken as the trajectory speed.

After the trajectory speed is obtained, a position of the face in the last frame of an image in the historical motion trajectory may be obtained, and the position of the face in the current frame is predicted according to the trajectory speed and the position of the face in the last frame of an image to obtain the predicted position, that is, the instruction may further perform the following operation:

obtaining a position of the face in the last frame of an image in the historical motion trajectory, and then predicting the position of the face in the current frame according to the trajectory speed and the position of the face in the last frame of an image to obtain the predicted position.

For example, a frame difference between the current frame and the last frame may be calculated, and a product of the frame difference and the trajectory speed is calculated; then, a sum of the product and the position of the face in the last frame is calculated to obtain the predicted position.

For specific implementation of the foregoing operations, reference may be made to the previous embodiments, and details are not described herein again.

The storage medium may include: a read-only memory (ROM), a random access memory (RAM), a magnetic disk, an optical disc, or the like.

Because the instructions stored in the storage medium may perform the operations in any face tracking method according to the embodiments of the disclosure, beneficial effects achieved by any face tracking method according to the embodiments of the disclosure may be implemented. For details, refer to the foregoing embodiments. Details are not described herein again.

At least one of the components, elements, modules or units described herein may be embodied as various numbers of hardware, software and/or firmware structures that execute respective functions described above, according to an example embodiment. For example, at least one of these components, elements or units may use a direct circuit structure, such as a memory, a processor, a logic circuit, a look-up table, etc. that may execute the respective functions through controls of one or more microprocessors or other control apparatuses. Also, at least one of these components, elements or units may be specifically embodied by a module, a program, or a part of code, which contains one or more executable instructions for performing specified logic functions, and executed by one or more microprocessors or other control apparatuses. Also, at least one of these components, elements or units may further include or implemented by a processor such as a central processing unit (CPU) that performs the respective functions, a microprocessor, or the like. Two or more of these components, elements or units may be combined into one single component, element or unit which performs all operations or functions of the combined two or more components, elements of units. Also, at least part of functions of at least one of these components, elements or units may be performed by another of these components, element or units. Further, although a bus is not illustrated in the block diagrams, communication between the components, elements or units may be performed through the bus. Functional aspects of the above example embodiments may be implemented in algorithms that execute on one or more processors. Furthermore, the components, elements or units represented by a block or processing operations may employ any number of related art techniques for electronics configuration, signal processing and/or control, data processing and the like.

A face tracking method and apparatus, and a storage medium provided by the embodiments of the disclosure are described in detail above. Specific examples are used in the context to explain the principles and implementation of the disclosure. The description of the embodiments are only used to assist in understanding the method of the disclosure and its core ideas. In addition, for a person skilled in the art, there will be changes in the specific implementation and application scope according to the ideas of the disclosure. In summary, the content of this specification cannot be construed as a limitation to the disclosure.

What is claimed is:

1. A method of tracking a face, performed by a network device, the method comprising:
determining a current frame from video stream data in response to receiving a face tracking instruction;
detecting a position of a face in the current frame, and obtaining a historical motion trajectory of the face in the current frame;
predicting the position of the face in the current frame based on the historical motion trajectory to obtain a predicted position of the face;
obtaining a correlation matrix of the historical motion trajectory and the face in the current frame based on the predicted position and the detected position; and
updating the historical motion trajectory based on the correlation matrix, and tracking the face in a next frame based on the updated historical motion trajectory.

2. The method according to claim 1, wherein the operation of predicting comprises:
obtaining a movement speed of the face in the historical motion trajectory by using a preset algorithm to obtain a trajectory speed; and
predicting the position of the face in the current frame based on the trajectory speed and the historical motion trajectory to obtain the predicted position of the face.

3. The method according to claim 2, wherein the operation of obtaining the movement speed of the face comprises:
obtaining key point information of the face in the historical motion trajectory by using a face registration algorithm; and
fitting the key point information by using a least-squares method to obtain, as the trajectory speed, a movement speed vector of the face in the historical motion trajectory.

4. The method according to claim 2, wherein the operation of obtaining the movement speed of the face comprises:
obtaining key point information of the face in the historical motion trajectory by using a face registration algorithm;
fitting the key point information by using a least-squares method to obtain a movement speed vector of the face in the historical motion trajectory;
obtaining a triaxial angle of the face in a last frame of an image in the historical motion trajectory by using a face pose estimation algorithm; and
adjusting the movement speed vector based on the triaxial angle to obtain the trajectory speed.

5. The method according to claim 4, wherein the operation of adjusting comprises:
obtaining a direction vector of the face in the last frame of the image based on the triaxial angle; and
obtaining a weighted average of the movement speed vector and the direction vector to obtain the trajectory speed.

6. The method according to claim 2, wherein the operation of predicting the position of the face in the current frame based on the trajectory speed and the historical motion trajectory comprises:
obtaining the position of the face in a last frame of an image in the historical motion trajectory; and
predicting the position of the face in the current frame based on the trajectory speed and the position of the face in the last frame of the image to obtain the predicted position of the face.

7. The method according to claim 6, wherein the operation of predicting the position of the face in the current frame according to the trajectory speed and the position of the face in the last frame of the image comprises:
obtaining a frame difference between the current frame and the last frame, and obtaining a product of the frame difference and the trajectory speed; and
obtaining a sum of the product and the position of the face in the last frame to obtain the predicted position of the face.

8. The method according to claim 1, wherein the operation of obtaining the historical motion trajectory comprises:
reading an existing historical motion trajectory of the face in the current frame; or
in response to non-existence of the historical motion trajectory, generating the historical motion trajectory of the face in the current frame.

9. The method according to claim 8, wherein the operation of generating the historical motion trajectory comprises:
obtaining, from the video stream data, a video stream data segment within a previous preset time range, relative to the current frame;
detecting positions of faces in a plurality of frames of images in the video stream data segment;
generating motion trajectories of the faces based on the positions; and
selecting, from the generated motion trajectories, the historical motion trajectory of the face in the current frame.

10. The method according to claim 1, wherein the operation of obtaining the correlation matrix comprises:
obtaining a degree of coincidence between the predicted position and the detected position; and
obtaining the correlation matrix of the historical motion trajectory and the face in the current frame based on the degree of coincidence.

11. The method according to claim 10, wherein the operation of obtaining the degree of coincidence between the predicted position and the detected position comprises:
determining an area of intersection and an area of union between a coordinate box in which the predicted position is located and a coordinate box in which the detected position is located; and
obtaining the degree of coincidence between the predicted position and the detected position based on the area of intersection and the area of union.

12. An apparatus for tracking a face, the apparatus comprising:
at least one memory configured to store program code; and
at least one processor configured to read the program code and operate as instructed by the program code, the program code comprising:
determining code configured to cause at least one of the at least one processor to determine a current frame from video stream data in response to receiving a face tracking instruction;
detecting code configured to cause at least one of the at least one processor to detect a position of a face in the current frame;
first obtaining code configured to cause at least one of the at least one processor to obtain a historical motion trajectory of the face in the current frame;
predicting code configured to cause at least one of the at least one processor to predict the position of the face in the current frame based on the historical motion trajectory to obtain a predicted position of the face;
second obtaining code configured to cause at least one of the at least one processor to obtain a correlation matrix of the historical motion trajectory and the face in the current frame based on the predicted position and the detected position; and
updating code configured to cause at least one of the at least one processor to update the historical motion trajectory based on the correlation matrix, and track the face in a next frame based on the updated historical motion trajectory.

13. The apparatus according to claim 12, wherein the predicting code comprises:
arithmetic code configured to cause at least one of the at least one processor to obtain a movement speed of the face in the historical motion trajectory by using a preset algorithm to obtain a trajectory speed; and
predicting sub-code code configured to cause at least one of the at least one processor to predict the position of the face in the current frame based on the trajectory speed and the historical motion trajectory to obtain the predicted position of the face.

14. The apparatus according to claim 13, wherein the arithmetic code causes at least one of the at least one processor to obtain key point information of the face in the historical motion trajectory by using a face registration algorithm, fit the key point information by using a least-squares method to obtain, as the trajectory speed, a movement speed vector of the face in the historical motion trajectory.

15. The apparatus according to claim 13, wherein the arithmetic code causes at least one of the at least one processor to obtain key point information of the face in the historical motion trajectory by using a face registration algorithm, fit the key point information by using a least-squares method to obtain a movement speed vector of the face in the historical motion trajectory, obtain a triaxial angle of the face in a last frame of an image in the historical motion trajectory by using a face pose estimation algorithm, and adjust the movement speed vector based on the triaxial angle to obtain the trajectory speed.

16. The apparatus according to claim 15, wherein the arithmetic code causes at least one of the at least one processor to obtain a direction vector of the face in the last frame of the image based on the triaxial angle, and obtain a weighted average of the movement speed vector and the direction vector to obtain the trajectory speed.

17. The apparatus according to claim 13, wherein the predicting sub-code code causes at least one of the at least one processor to obtain the position of the face in a last frame of an image in the historical motion trajectory, and predict the position of the face in the current frame based on the trajectory speed and the position of the face in the last frame of the image to obtain the predicted position of the face.

18. The apparatus according to claim 17, wherein the predicting sub-code code causes at least one of the at least one processor to obtain a frame difference between the current frame and the last frame, obtain a product of the frame difference and the trajectory speed, and obtain a sum of the product and the position of the face in the last frame to obtain the predicted position of the face.

19. A network device, comprising:
at least one processor;
at least one memory, configured to store instructions executable by the at least one processor to cause the at least one processor to perform the method according to claim 1.

20. A non-transitory computer readable storage medium, storing a plurality of instructions, the plurality of instructions being executable by at least one processor to cause the at least one processor to perform:
determining a current frame from video stream data in response to receiving a face tracking instruction;
detecting a position of a face in the current frame, and obtaining a historical motion trajectory of the face in the current frame;
predicting the position of the face in the current frame based on the historical motion trajectory to obtain a predicted position of the face;
obtaining a correlation matrix of the historical motion trajectory and the face in the current frame based on the predicted position and the detected position; and
updating the historical motion trajectory based on the correlation matrix, and tracking the face in a next frame based on the updated historical motion trajectory.
